(19) United States
(12) Patent Application Publication
(10) Pub. No.: US 2020/0201095 A1
(43) Pub. Date: Jun. 25, 2020

(54) LIQUID CRYSTAL DISPLAY DEVICE

(71) Applicant: SHARP KABUSHIKI KAISHA, Sakai City, Osaka (JP)

(72) Inventors: Yoshimasa CHIKAMA, Sakai City (JP); Jun NISHIMURA, Sakai City (JP); Yoshiharu HIRATA, Sakai City (JP)

(73) Assignee: Sharp Kabushiki Kaisha, Sakai City, Osaka (JP)

(21) Appl. No.: 16/619,645

(22) PCT Filed: Jun. 1, 2018
(86) PCT No.: PCT/JP2018/021180

§ 371 Date: Dec. 5, 2019

(30) Foreign Application Priority Data
Jun. 9, 2017 (JP) 2017-114107

(51) Int. Cl. G02F 1/135; G06F 3/044

(52) U.S. Cl. CPC G02F 1/1354; G02F 2001/1351; G06F 3/044

(57) ABSTRACT

A liquid crystal display device of the present invention includes: a pair of substrates; a liquid crystal layer; a plurality of TFTs; a plurality of pixel electrodes; a common electrode placed in such a manner as to overlap the pixel electrodes via an insulating film; a color filter placed between the TFTs and the pixel electrodes and placed in such a manner as to overlap each of the plurality of pixel electrodes, that includes a plurality of colored portions that exhibit different colors from one another; and a light-blocking conducting film provided on an array substrate, placed closer to the liquid crystal layer than the TFTs while having a light blocking effect, placed in such a manner as to overlap a boundary portion between two adjacent colored portions of the plurality of colored portions, and electrically connected to the common electrode.

### TECHNICAL FIELD

The present invention relates to a liquid crystal display device.

### BACKGROUND ART

There has been a conventionally known a liquid crystal display device configured such that a TFT substrate is provided with a color filter and a counter substrate is provided with a black matrix (PTL 1 listed below). The color filter includes a plurality of colored portions placed in such a manner as to correspond to each separate pixel.

### CITATION LIST

### Patent Literature

PTL 1: Japanese Unexamined Patent Application Publication No. 2014-41268

### Technical Problem

The foregoing configuration raises concern about a situation where of light traveling toward a liquid crystal layer through the TFT substrate, light having obliquely fallen on one of two adjacent colored portions travels toward a place in the liquid crystal layer that corresponds to the other colored portion. This raises concern about the occurrence of a mixture of colors of pixels, for example, due to the occurrence of a situation or the like where light having passed through a red colored portion is emitted from a pixel that corresponds to a green colored portion.

### SUMMARY OF INVENTION

The present invention was made in view of the above circumstances. An object is to reduce a mixture of colors of pixels.

### Solution to Problem

In order to solve the foregoing problems, a liquid crystal display device of the present invention includes: a pair of substrates placed opposite each other; a liquid crystal layer placed between the two substrates; a plurality of switching elements provided on a first one of the two substrates; a plurality of pixel electrodes provided on the first substrate, electrically connected to the plurality of switching elements, respectively, and placed closer to the liquid crystal layer than the plurality of switching elements; a common electrode, provided on the first substrate, at least a part of which overlaps the pixel electrodes via an insulating film; a color filter, provided on the first substrate, placed between the switching elements and the pixel electrodes, and placed in such a manner as to overlap each of the plurality of pixel electrodes, that includes a plurality of colored portions that exhibit different colors from one another; and a light-blocking conducting film provided on the first substrate, placed closer to the liquid crystal layer than the switching elements while having a light blocking effect, placed in such a manner as to overlap a boundary portion between two adjacent colored portions of the plurality of colored portions, and electrically connected to the common electrode.

In a case where light has fallen on a side of the color filter opposite to the liquid crystal layer, of light having obliquely fallen on one of the two adjacent colored portions, light traveling toward a place in the liquid crystal layer that corresponds to the other color portion can be blocked by the light-blocking conducting film, so that a mixture of colors of pixels can be reduced. Further, the light-blocking conducting film, which is electrically connected to the common electrode, can for example achieve a reduction in resistance of the common electrode and be used as a wire through which to transmit a signal to the common electrode.

Further, the light-blocking conducting film may be placed closer to the liquid crystal layer than the color filter. If the light-blocking conducting film is placed opposite the liquid crystal layer behind the color filter, a portion of light traveling toward the liquid crystal layer that has passed through an area near the light-blocking conducting film travels toward the colored portions. As a result, this raises concern about a situation where the light having passed through the area near the light-blocking conducting film passes through one of the colored portions first and then travels toward a place in the liquid crystal layer that corresponds to the other colored portion. On the other hand, according to the foregoing configuration, light having passed through the colored portions can be blocked by the light-blocking conducting film, so that a mixture of colors of pixels can be more surely reduced.

Further, the light-blocking conducting film may make surface contact with the common electrode. Bringing the light-blocking conducting film into surface contact with the common electrode can make a conducting portion thicker by the thickness of the light-blocking conducting film, thus making it possible to achieve a reduction in resistance.

Further, the common electrode may serve as a position detection electrode that forms an electrostatic capacitance with a position input body which performs a position input and that detects a position input performed by the position input body, and the light-blocking conducting film may be a wire that is capable of transmitting a signal to the position detection electrode. The light-blocking conducting film can be used as a wire for the position detection electrode.

Further, each of the switching elements may include a source electrode, the first substrate may be provided with a source line that is electrically connected to the source electrode, and the light-blocking conducting film may be placed in such a manner as to overlap the source line. This configuration can achieve higher efficiency in the use of light than a configuration in which the light-blocking conducting film and the source line are placed in such a manner as not to overlap each other.

Each of the switching elements may be a TFT including an oxide semiconductor. Since the oxide semiconductor is high in electron mobility, the switching element can be made smaller in size. This brings about an advantage in terms of an increase in definition and an increase in aperture ratio. Further, a reduction in leak current brings about an advantage in terms of a reduction in power consumption. Further, the oxide semiconductor may contain indium (In), gallium (Ga), zinc (Zn), and oxygen (O).

### Advantageous Effects of Invention

The present invention makes it possible to reduce a mixture of colors of pixels.

### BRIEF DESCRIPTION OF DRAWINGS

FIG. 1 is a cross-sectional view of a liquid crystal display device according to Embodiment 1 of the present invention as taken along a longitudinal direction (Y-axis direction).

FIG. 2 is a cross-sectional view showing a liquid crystal panel.

FIG. 3 is a plan view showing a part of an array substrate of the liquid crystal panel.

FIG. 4 is a plan view showing a pixel in the array substrate.

FIG. 5 is a plan view showing an array substrate according to Embodiment 2.

FIG. 6 is a cross-sectional view showing the array substrate according to Embodiment 2.

FIG. 7 is a cross-sectional view showing an array substrate according to Embodiment 3.

FIG. 8 is a plan view showing the array substrate according to Embodiment 3.

FIG. 9 is a cross-sectional view showing an array substrate according to Embodiment 4.

FIG. 10 is a cross-sectional view showing an array substrate according to Embodiment 5.

FIG. 11 is a cross-sectional view showing a modification of Embodiment 5.

### DESCRIPTION OF EMBODIMENTS

### Embodiment 1

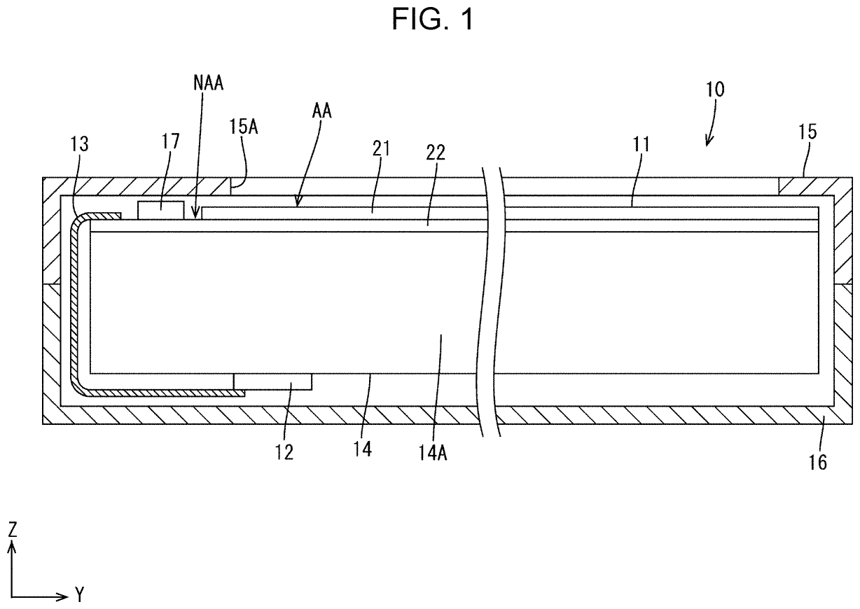

Embodiment 1 of the present invention is described with reference to FIGS. 1 to 4. Some of the drawings show an X axis, a Y axis, and a Z axis and are drawn so that the direction of each axis is an identical direction in each drawing. As shown in FIG. 1, a liquid crystal display device 10 includes a liquid crystal panel 11 (display panel), a driver 17 (panel drive unit) that drives the liquid crystal panel 11, a control circuit substrate 12 (external signal supply source) that supplies the driver 17 with various types of input signal from outside, a flexible substrate 13 (external connection component) that electrically connects the liquid crystal panel 11 and the control circuit substrate 12 to each other, and a backlight device 14 (lighting device) that supplies the liquid crystal panel 11 with light. As shown in FIG. 1, the backlight device 14 includes a chassis 14A that is substantially in the shape of a box having an opening facing forward (i.e. toward the liquid crystal panel 11), a light source (not illustrated; e.g. a cold-cathode tube, an LED, organic EL, or the like), and an optical member (not illustrated) placed in such a manner as to cover the opening of the chassis 14A. The optical member has a function of, for example, converting light emitted from the light source into planar light.

Further, the liquid crystal display device 10 includes a pair of front and back exterior members 15 and 16 assembled to each other to accommodate and retain the liquid crystal panel 11 and the backlight device 14. Of them, the front exterior member 15 has an opening 15A formed therein so that an image displayed in a display area AA of the liquid crystal panel 11 can be viewed from outside. The liquid crystal display device 10 according to the present embodiment is one that is used in various types of electronic apparatus (not illustrated) such as mobile phones (including smartphones and the like), laptop personal computers (including tablet laptop personal computers and the like), wearable terminals (including smartwatches and the like), portable information terminals (including electronic books, PDAs, and the like), portable game machines, and digital photo frames. For this purpose, the liquid crystal panel 11 of the liquid crystal display device 10 has a screen size of approximately several inches to several tens of inches, which is a size generally categorized as a small size or a small-to-medium size.

The liquid crystal panel 11 has the display area AA, which is capable of displaying an image, and a non-display area NAA placed on the periphery in such a manner as to surround the display area AA. The liquid crystal panel 11 has a vertically long square shape (rectangular shape) as a whole, with the driver 17 attached to one end of the liquid crystal panel 11 in a long-side direction (i.e. a right-left direction of FIG. 1). The driver 17 is composed of an LSI chip having a drive circuit inside and, by operating in accordance with a signal that is supplied from the control circuit substrate 12 serving as a signal supply source, generates an output signal by processing an input signal that is supplied from the control circuit substrate 12 serving as a signal supply source and outputs the output signal to the display area of the liquid crystal panel 11.

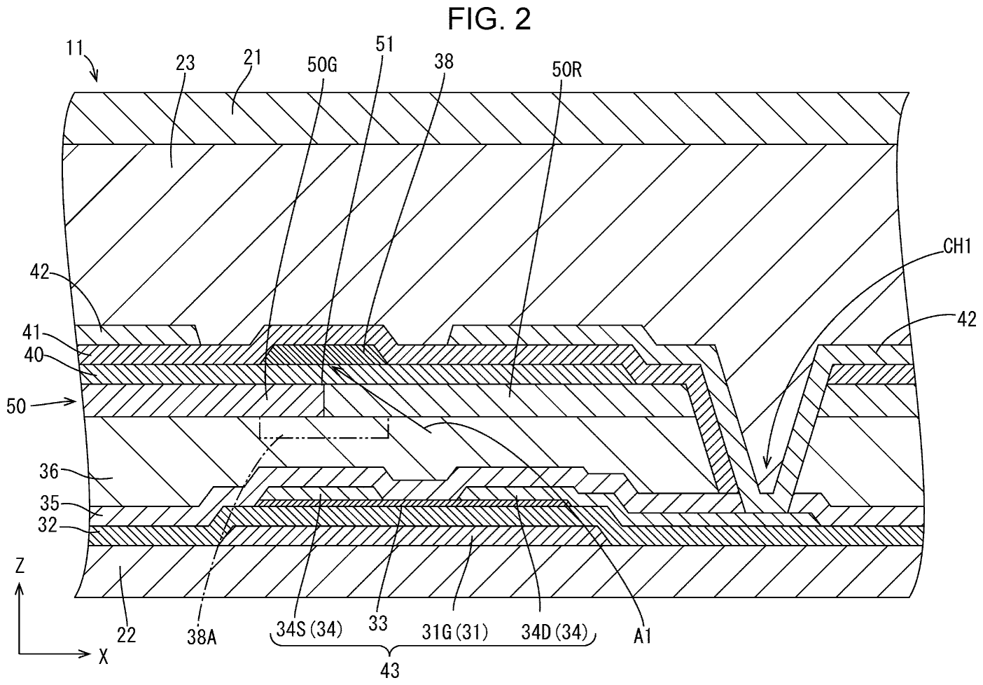

As shown in FIG. 2, the liquid crystal panel 11 includes a pair of substrates 21 and 22 placed opposite each other, a liquid crystal layer 23 (medium layer), placed between the two substrates 21 and 22, that contains liquid crystal molecules that constituting a substance whose optical properties vary in the presence of the application of an electric field, and a seal member (not illustrated), placed between the two substrates 21 and 22, that seals the liquid crystal layer 23 by surrounding the liquid crystal layer 23. The pair of substrates 21 and 22 include a front (front side) substrate serving as a counter substrate 21 and a back (back side) substrate serving as an array substrate 22 (active matrix substrate, element substrate). The counter substrate 21 and the array substrate 22 each includes a glass substrate made of glass and various types of film formed and stacked on an inner side of the glass substrate. It should be noted that polarizing plates (not illustrated) are pasted to outer sides of the two substrates 21 and 22, respectively. An alignment film (not illustrated) is provided on the inner side of the counter substrate 21 (that faces the liquid crystal layer 23).

As shown in FIG. 2, various types of film are stacked on an inner side of the array substrate 22 (that faces the liquid crystal layer 23 and that faces the counter substrate 21). On the array substrate 22, a gate conducting film 31 (gate metal), a gate insulating film 32, a semiconductor film 33, a source conducting film 34 (source metal), an insulating film 35, a planarizing film 36, a color filter 50, a common electrode 40, a light-blocking conducting film 38, an insulating film 41, and a pixel electrode 42 are formed and stacked in this order from the bottom. Such an array substrate 22 is fabricated by repeating a photolithography step and an etching step more than once.

The gate conducting film 31 has electrical conductivity and a light blocking effect by being a single layer made of one type of metal material or a laminated film or alloy made of different types of metal material, and constitutes a gate electrode 31G of a TFT 43 provided on the array substrate 22 and a gate line (not illustrated). An appropriately usable example of the gate conducting film 31 is a film containing a metal such as copper (Cu), titanium (Ti), molybdenum (Mo), aluminum (Al), magnesium (Mg), cobalt (Co), chromium (Cr), or tungsten (W), an alloy thereof, or a metal nitride thereof. The gate insulating film 32 mainly keeps the gate conducting film 31 and the semiconductor film 33 insulated from each other. The semiconductor film 33 is constituted by a thin film made, for example, of an oxide semiconductor as a material, and constitutes a channel part (semiconductor part) in the TFT 43 that is connected to the source electrode 34S and the drain electrode 34D. A possible example of the oxide semiconductor of which the semiconductor film 33 is made is an oxide semiconductor (semiconductor based on In—Ga—Zn—O) containing In (indium), Ga (gallium), Zn (zinc), and O (oxygen). Since the oxide semiconductor is high in electron mobility, the TFT 43 can be made smaller in size. This brings about an advantage in terms of an increase in definition and an increase in aperture ratio. Further, a reduction in leak current brings about an advantage in terms of a reduction in power consumption. Alternatively, an amorphous silicon TFT or a polysilicon TFT may be applied as the TFT 43.

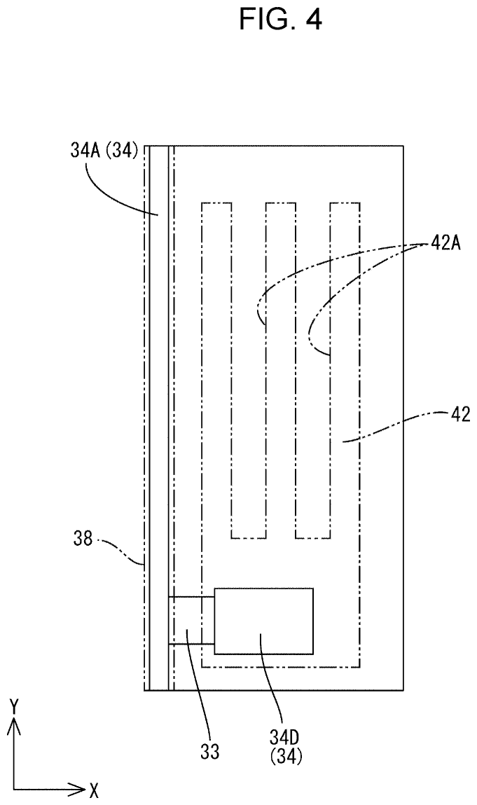

The source conducting film 34 has electrical conductivity and a light blocking effect by being a single layer made of one type of metal material or a laminated film or alloy made of different types of metal material, and constitutes a source line 34A (see FIG. 4), source and drain electrodes 34S and 34D of the TFT 43, and the like. That is, the source conducting film 34 can also be called a drain conducting film, and the source line 34A, the source electrode 34S, and the drain electrode 34D are placed at the same level. An appropriately usable example of the source conducting film 34 is a film containing a metal such as copper (Cu), titanium (Ti), molybdenum (Mo), aluminum (Al), magnesium (Mg), cobalt (Co), chromium (Cr), or tungsten (W), an alloy thereof, or a metal nitride thereof. The insulating film 35 is placed on top of at least the source conducting film 34. The planarizing film 36 is placed on top of the insulating film 35, and is made, for example, of an acrylic resin material (e.g. polymethylmethacrylate (PMMA)), which is an organic resin material. The planarizing film 36 is an organic insulating film that is greater in film thickness than other organic insulating films (insulating films 32, 35, and 41) and that has a function of planarizing a surface.

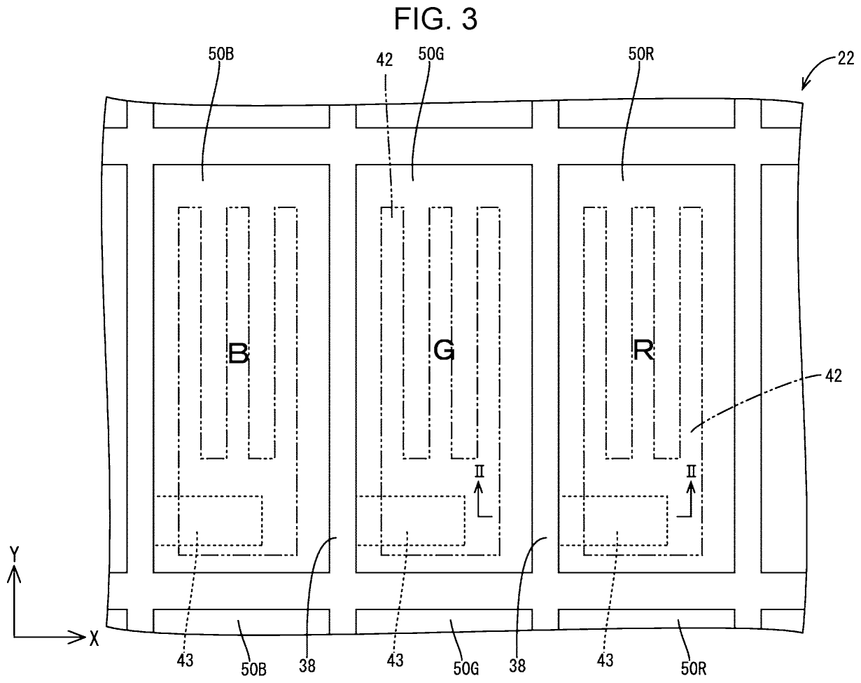

The color filter 50 is placed between the planarizing film 36 and the common electrode 40 and, by extension, between the TFT 43 and the pixel electrode 42. As shown in FIG. 3, the color filter 50 includes a plurality of colored portions 50R, 50G, and 50B arranged in a matrix. The colored portions 50R, 50G, and 50B exhibit different colors from one another and, specifically, are composed of three colors, namely red (R) colored portions 50R, green (G) colored portions 50G, and blue (B) colored portions 50B. As shown in FIG. 3, each of the colored portions 50R, 50G, and 50B has a square shape in plan view and is placed opposite a corresponding pixel electrode 42. That is, the plurality of colored portions 50R, 50G, and 50B are placed in such a manner as to overlap a plurality of the pixel electrodes 42, respectively. A pixel is constituted by a set of colored portions and a pixel electrode 42 placed opposite each other. The common electrode 40 is placed on top of the color filter 50. The common electrode 40 and the pixel electrode 42 are composed of a transparent electrode film (e.g. ITO (indium tin oxide) or the like). The common electrode 40 is placed in such a manner as to overlap the pixel electrodes 42 via the insulating film 41.

An appropriately usable example of the light-blocking conducting film 38 is a film containing a metal such as copper (Cu), titanium (Ti), molybdenum (Mo), aluminum (Al), magnesium (Mg), cobalt (Co), chromium (Cr), or tungsten (W), an alloy thereof, or a metal nitride thereof. The light-blocking conducting film 38 has a light blocking effect and is placed closer to the liquid crystal layer 23 than the TFT 43. Further, the light-blocking conducting film 38 is placed closer to the liquid crystal layer 23 than the color filter 50 and, as shown in FIGS. 2 and 3, is placed in such a manner as to overlap a boundary portion 51 between colored portions of two different colors (in FIG. 2, the colored portions 50R and 50G) of the plurality of colored portions 50R, 50G, and 50B. The light-blocking conducting film 38 is placed on top of the common electrode 40, and is electrically connected to the common electrode 40 by making surface contact with the common electrode 40. Further, as shown in FIG. 4, the light-blocking conducting film 38 is placed in such a manner as to overlap the source line 34A, which is electrically connected to the source electrode 34S.

The insulating film 41 is placed in such a manner as to cover the common electrode 40 and the light-blocking conducting film 38. The pixel electrode 42 is placed on top of the insulating film 41. The gate insulating film 32, the insulating film 35, and the insulating film 41 are inorganic insulating films made of an inorganic material such as silicon nitride (SiNₓ) or silicon oxide (SiO₂), and have moisture-proof properties. A plurality of the pixel electrodes 42 are arranged in a matrix in the display area. Further, in the display area, a plurality of the TFTs 43, which serve as switching elements, are arranged in a matrix in correspondence with the pixel electrodes 42. The TFT 43 includes the gate electrode 31G, the semiconductor film 33, the source electrode 34S, and the drain electrode 34D. The pixel electrode 42 is placed closer to the liquid crystal layer 23 than the TFT 43 and is electrically connected to the drain electrode 34D via a contact hole CH1 formed in the insulating film 35.

The TFT 43 is provided at a place where a gate line (not illustrated) and the source line 34A cross each other, and is driven in accordance with various types of signal that are supplied to the gate line and the source line 34A, and the driving of the TFT 43 entails control of supply of a potential to the pixel electrode 42. The pixel electrode 42 has a plurality of slits 42A as indicated by chain double-dashed lines in FIG. 4. When a potential difference is generated between the pixel electrode 42 and the common electrode 40, a fringe field (oblique field) including a component along a board surface of the array substrate 22 and a component in a direction normal to the board surface of the array substrate 22. This makes it possible to display an image in the display area by utilizing the fringe field to control a state of alignment of the liquid crystal molecules contained in the liquid crystal layer 23. That is, an operation of the liquid crystal panel 11 according to the present embodiment is an FFS (fringe field switching) mode.

Next, effects of the present embodiment are described. In the present embodiment, light emitted from the backlight device 14 falls on a side of the color filter 50 opposite to the liquid crystal layer 23. In such a case, of light having obliquely fallen on one (in FIG. 2, the colored portion 50R) of two adjacent colored portions, light (indicated by an arrow μl in FIG. 2) traveling toward a place in the liquid crystal layer that corresponds to the other color portion (in FIG. 2, the colored portion 50G) can be blocked by the light-blocking conducting film 38, so that a mixture of colors of pixels can be reduced. Further, the light-blocking conducting film 38, which is electrically connected to the common electrode 40, makes it possible to achieve a reduction in resistance of the common electrode.

Further, the light-blocking conducting film 38 is placed closer to the liquid crystal layer 23 than the color filter 50. If the light-blocking conducting film 38 is placed opposite the liquid crystal layer 23 behind the color filter 50 (see a light-blocking conducting film 38A indicated by a chain double-dashed lines in FIG. 2), a portion of light traveling toward the liquid crystal layer 23 that has passed through an area near the light-blocking conducting film 38A travels toward the colored portions. As a result, this raises concern about a situation where the light having passed through the area near the light-blocking conducting film 38A passes through one of the colored portions first and then travels toward a place in the liquid crystal layer 23 that corresponds to the other colored portion. On the other hand, according to the foregoing configuration, light having passed through the colored portions can be blocked by the light-blocking conducting film 38, so that a mixture of colors of pixels can be more surely reduced.

Further, the light-blocking conducting film 38 is configured to make surface contact with the common electrode 40. Bringing the light-blocking conducting film 38 into surface contact with the common electrode 40 can make a conducting portion (the common electrode 40 and the light-blocking conducting film 38) thicker by the thickness of the light-blocking conducting film 38, thus making it possible to achieve a reduction in resistance. Further, the TFT 43, which serves as a switching element, includes the source electrode 34S. The array substrate 22 is provided with the source line 34A, which is electrically connected to the source electrode 34S. The light-blocking conducting film 38 is placed in such a manner as to overlap the source line 34A. This configuration can achieve higher efficiency in the use of light than a configuration in which the light-blocking conducting film 38 and the source line 34A are placed in such a manner as not to overlap each other (e.g. in such a manner as to be displaced from each other in the X-axis direction).

### Embodiment 2

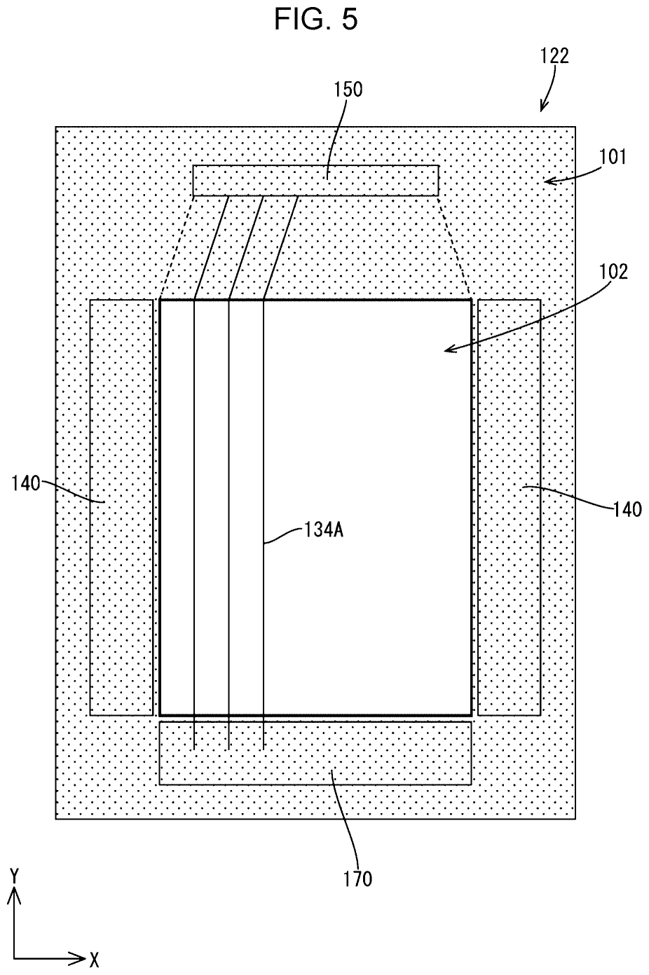

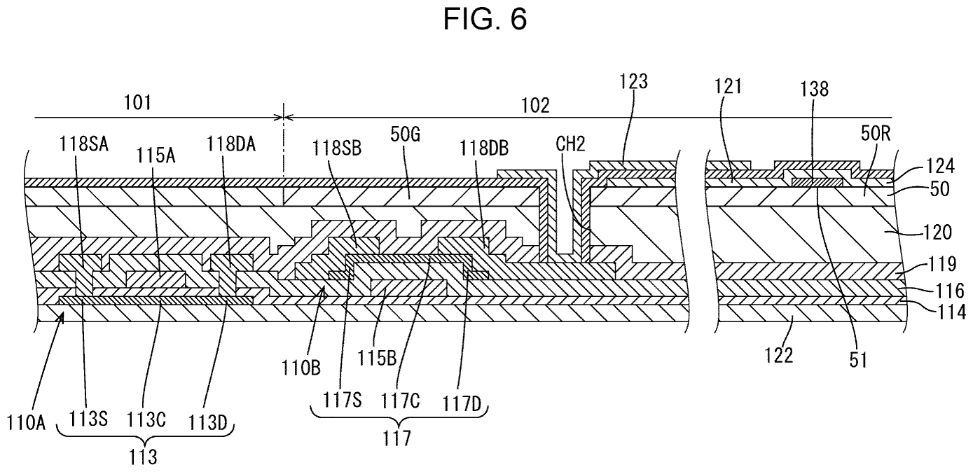

Next, Embodiment 2 of the present invention is described with reference to FIGS. 5 and 6. A repeated description is omitted by assigning identical signs to components which are identical to those of the foregoing embodiment. The present embodiment differs from the foregoing embodiment in that two types of TFT (namely a crystalline silicon TFT 110A and an oxide semiconductor TFT 110B) are provided on top of an array substrate 122. The array substrate 122 is provided with oxide semiconductor TFTs 110B for each separate pixel. Further, in the present embodiment, a part or the whole of a peripheral drive circuit is integrally formed on top of the same substrate as the oxide semiconductor TFT 110B, which serves as a pixel TFT. Such an array substrate is called a driver monolithic array substrate. In the driver monolithic array substrate, the peripheral drive circuit is provided in an area (non-display area or frame area) other than an area (display area) including a plurality of pixels. The peripheral drive circuit is constituted by a TFT (circuit TFT) an example of which is the crystalline silicon TFT 110A, whose active layer is a polycrystalline silicon film. By thus using the oxide semiconductor TFT 110B as a pixel TFT and using the crystalline silicon TFT 110A as a circuit TFT, it is made possible to reduce power consumption in the display area and, furthermore, it is made possible to make the frame area smaller.

Next, a more specific configuration of the array substrate 122 of the present embodiment is described with reference to the drawings. FIG. 5 is a schematic plan view showing an example of a planar structure of the array substrate 122 of the present embodiment, and FIG. 6 is a cross-sectional view showing a cross-sectional structure of the crystalline silicon TFT 110A and the oxide semiconductor TFT 110B in the array substrate 122. As shown in FIG. 5, the array substrate 122 includes a display area 102 including a plurality of pixels and an area (non-display area) other than the display area 102. The non-display area includes a drive circuit formation area 101 where a drive circuit is provided. In the drive circuit formation area 101, a gate driver 140, a check circuit 170, and the like are provided. Formed in the display area 102 are a plurality of gate lines (not illustrated) that extend in a row-wise direction and a plurality of source lines 134A that extend in a column-wise direction. The gate lines are connected to terminals, respectively, of the gate driver 140. The source lines 134A are connected to terminals, respectively, of a driver 150 mounted on the array substrate 122. In the array substrate 122, as shown in FIG. 6, each pixel of the display area 102 is provided with an oxide semiconductor TFT 110B as a pixel TFT, and the drive circuit formation area 101 is provided with a crystalline silicon TFT 110A as a circuit TFT.

The crystalline silicon TFT 110A has an active region composed mainly of crystalline silicon. The oxide semiconductor TFT 110B has an active region composed mainly of an oxide semiconductor. The term “active region” here refers to a region, included in a semiconductor layer serving as an active layer of a TFT, in which a channel is formed. The crystalline silicon TFT 110A has a crystalline silicon semiconductor film 113 (e.g. a low-temperature polysilicon film), an insulating film 114 covering the crystalline silicon semiconductor film 113, and a gate electrode 115A provided on top of the insulating film 114. A portion of the insulating film 114 located between the crystalline silicon semiconductor film 113 and the gate electrode 115A functions as a gate insulating film of the crystalline silicon TFT 110A. The crystalline silicon semiconductor film 113 has a region (active region) 113C in which a channel is formed and source and drain regions 113S and 113D located on both sides, respectively, of the active region. In this example, a portion of the crystalline silicon semiconductor film 113 that overlaps the gate electrode 115A via the insulating film 114 serves as the active region 113C. The crystalline silicon TFT 110A also has source and drain electrodes 118SA and 118DA connected to the source and drain regions 113S and 113D, respectively. The source electrode 118SA and the drain electrode 118DA are provided on top of an insulating film 116 covering the gate electrode 115A, and are connected to the crystalline silicon semiconductor film 113 via a contact hole formed in the insulating films 114 and 116.

The oxide semiconductor TFT 110B has a gate electrode 115B, an insulating film 116 covering a gate electrode 115B, and an oxide semiconductor film 117 disposed on top of the insulating film 116. The oxide semiconductor film 117 is formed on top of the insulating film 116. A portion of the insulating film 116 located between the gate electrode 115B and the oxide semiconductor film 117 functions as a gate insulating film of the oxide semiconductor TFT 110B. The oxide semiconductor film 117 has a region (active region 117C) in which a channel is formed and source contact and drain contact regions 117S and 117D located on both sides, respectively, of the active region. A portion of the oxide semiconductor film 117 that overlaps the gate electrode 115B via the insulating film 116 serves as the active region 117C. Further, the oxide semiconductor TFT 110B has source and drain electrodes 118SB and 118DB connected to the source contact and drain contact regions 117S and 117D, respectively.

The TFTs 110A and 110B are covered with an insulating film 119 and a planarizing film 120. In the oxide semiconductor TFT 110B, the gate electrode 115B, the source electrode 118SB, and the drain electrode 118DB are connected to a gate line (not illustrated), a source line 134A (see FIG. 5), and a pixel electrode 123, respectively. The drain electrode 118DB is connected to the corresponding pixel electrode 123 via a contact hole CH2 formed in the insulating film 119 and the planarizing film 120. The source electrode 118SB is supplied with an image signal via the source line 134A, and a necessary charge is written into the pixel electrode 123 in accordance with a signal from the gate line. Further, a common electrode 121 is formed on top of the planarizing film 120, and an insulating film 124 is formed between the common electrode 121 and the pixel electrode 123.

The crystalline silicon TFT 110A has a top-gate structure in which the crystalline silicon semiconductor film 113 is disposed between the gate electrode 115A and the array substrate 122. Meanwhile, the oxide semiconductor TFT 110B (switching element) has a bottom-gate structure in which the gate electrode 115B is disposed between the oxide semiconductor film 117 and the array substrate 122. Employing such structures makes it possible to reduce the number of manufacturing steps and the cost of manufacturing in integrally forming two types of TFT 110A and 110B on top of the array substrate 122. The crystalline silicon TFT 110A and the oxide semiconductor TFT 110B are not limited to the aforementioned TFT structures. For example, these TFTs 110A and 110B may have the same TFT structure. Alternatively, the crystalline silicon TFT 110A may have a bottom-gate structure, and the oxide semiconductor TFT 110B may have a top-gate structure. Further, in the case of a bottom-gate structure, it may be of a channel-etch type or an etch-stop type as in the case of the crystalline silicon TFT 110A. Further, it may be of a bottom-contact type in which a source electrode and a drain electrode are located below a semiconductor layer.

The insulating film 116, which serves as the gate insulating film of the oxide semiconductor TFT 110B, is extended to a region in which the crystalline silicon TFT 110A is formed, and functions as an interlayer insulating film that covers the gate electrode 115A and crystalline silicon semiconductor film 113 of the crystalline silicon TFT 110A. The gate electrode 115A of the crystalline silicon TFT 110A and the gate electrode 115B of the oxide semiconductor TFT 110B may be formed from the same type of conducting film. Further, the source and drain electrodes 118SA and 118DA of the crystalline silicon TFT 110A and the source and drain electrodes 118SB and 118DB of the oxide semiconductor TFT 110B may be formed from the same type of conducting film. The formation from the same type of conducting film makes it possible to further reduce the number of steps.

In the present embodiment, the oxide semiconductor layer 117 contains, for example, a semiconductor based on In-Ga—Zn—O hereinafter referred to as “In-Ga—Zn—O semiconductor”). In this example, the In-Ga—Zn—O semiconductor is a ternary oxide of In (indium), Ga (gallium), and Zn (zinc) and, without a particular limitation on the proportions (composition ratios) of In, Ga, and Zn, contains, for example, In:Ga:Zn=2:2:1, In:Ga:Zn=1:1:1, In:Ga:Zn=1:1:2, or the like. The semiconductor based on In-Ga—Zn—O may be amorphous or crystalline. A preferred example of a crystalline semiconductor based on In-Ga—Zn—O is a crystalline semiconductor based on In-Ga—Zn—O whose c axis is oriented substantially perpendicular to a layer plane. A crystal structure of such an In-Ga—Zn—O semiconductor is disclosed, for example, in Japanese Unexamined Patent Application Publication No. 2012-134475. The entire contents of Japanese Unexamined Patent Application Publication No. 2012-134475 are hereby incorporated by reference.

The oxide semiconductor layer 117 may contain another oxide semiconductor instead of the In-Ga—Zn—O semiconductor. For example, the oxide semiconductor layer 117 may contain a Zn—O semiconductor, an In—Zn—O semiconductor, a Zn—Ti—O semiconductor, a Cd—Ge—O semiconductor, a Cd—Pb—O semiconductor, a CdO (cadmium oxide), a Mg—Zn—O semiconductor, an In—Sn—Zn—O semiconductor (e.g. In₂O₃—SnO₂—ZnO), an In—Ga—Sn—O semiconductor, or the like. In the present embodiment, the color filter 50 is placed on top of the planarizing film 120. A light-blocking conducting film 138 is placed closer to the liquid crystal layer (on the upper side of FIG. 6) than the color filter 50, and is placed in such a manner as to overlap a boundary portion 51 between two adjacent colored portions (in FIG. 6, the colored portions 50R and 50G) of the plurality of colored portions 50R, 50G, and 50B. The light-blocking conducting film 138 is sandwiched between the color filter 50 and the common electrode 121, is electrically connected to the common electrode 121 by making surface contact with the common electrode 121. That is, while Embodiment 1 described above has illustrated a configuration in which a light-blocking conducting film is placed at a higher level than a common electrode, the light-blocking conducting film 138 may be placed at a lower level than the common electrode 121.

### Embodiment 3

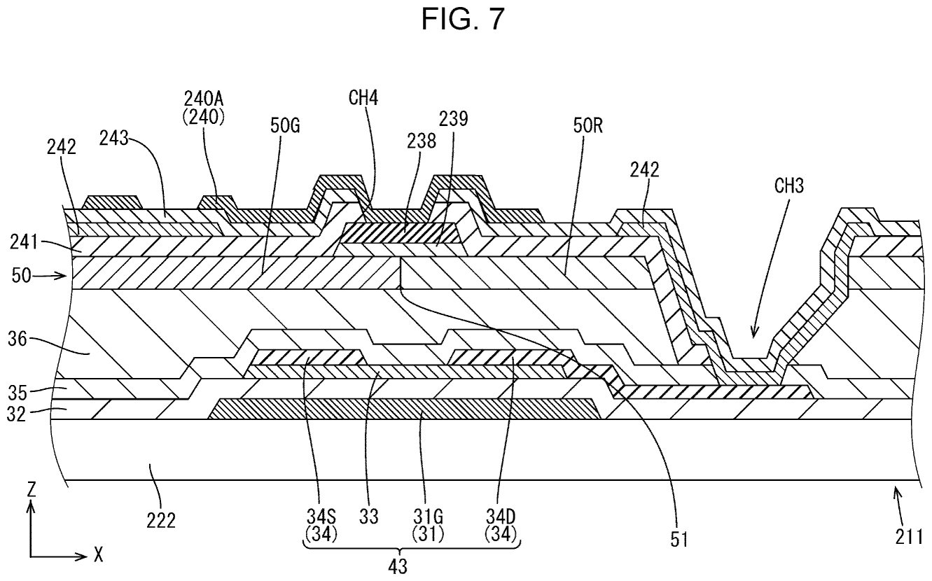

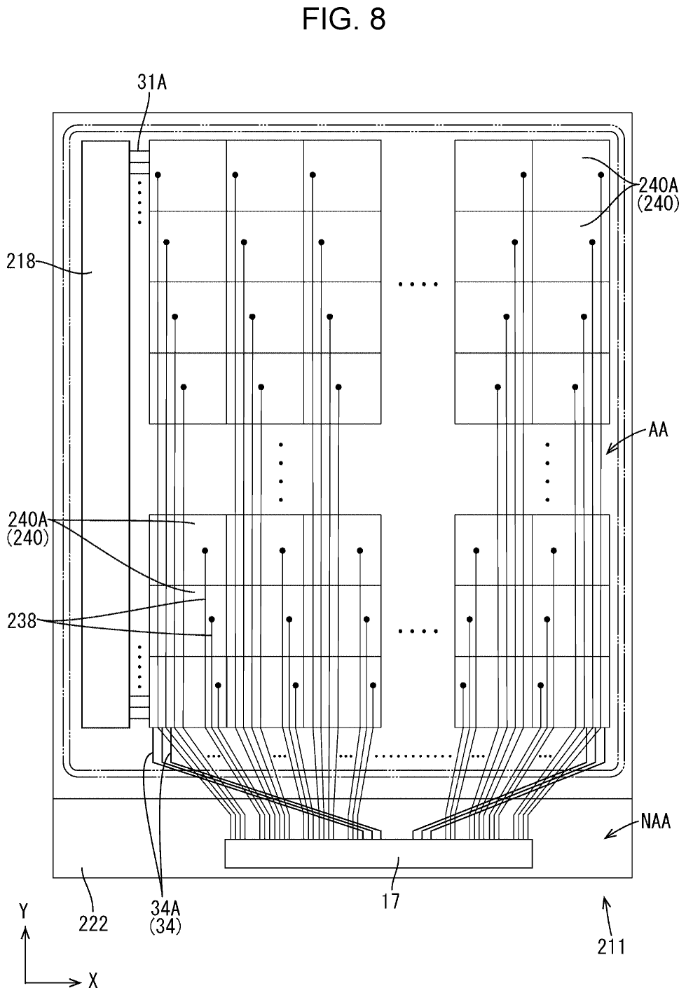

Next, Embodiment 3 of the present invention is described with reference to FIGS. 7 and 8. A repeated description is omitted by assigning identical signs to components which are identical to those of the foregoing embodiments. The present embodiment differs from each of the foregoing embodiments in terms of a laminated structure on top of an array substrate 222. On top of the array substrate 222 of the present embodiment, as shown in FIG. 7, an insulating film 241, a pixel electrode 242, an insulating film 243, and a common electrode 240 are stacked in this order on top of the color filter 50. The pixel electrode 242 is connected to the drain electrode 34D via a contact hole CH3 bored through the insulating films 35 and 241 and the planarizing film 36. A liquid crystal panel 211 according to the present embodiment has both a display function of displaying an image and a touch panel function (position input function) of detecting a position (input position) that a user inputs on the basis of an image that is displayed, and is integrated (by in-cell technology) with a touch panel pattern for fulfilling the touch panel function. The touch panel pattern adopts a so-called projection capacitive scheme, and a detection scheme of the touch panel pattern is a self-capacitance scheme. As shown in FIG. 8, the touch panel pattern is constituted by a plurality of position detection electrodes 240A arranged in a matrix within a board surface of the array substrate 222.

When a user of the liquid crystal display device moves his/her finger (position input body; not illustrated), which is a conductor, nearer to a surface (display surface) of the liquid crystal panel 211, electrostatic capacitances are formed between the finger and the touch electrodes 240A. As a result, an electrostatic capacitance that is detected by a touch electrode 240A located near the finger is different from that which is detected by a touch electrode 240A located away from the finger. This makes it possible to detect an input position on the basis of the difference. Moreover, the position detection electrodes 240A are constituted by the common electrode 240 provided on the array substrate 222. A light-blocking conducting film 238 is placed in such a manner as to overlap a boundary portion 51 between two adjacent colored portions (in FIG. 7, the colored portions 50R and 50G) of the plurality of colored portions 50R, 50G, and 50B. Further, as shown in FIG. 7, a conducting film 239 may be sandwiched between the light-blocking conducting film 238 and the color filter 50 in order to improve adhesion between the light-blocking conducting film 238 and the color filter 50.

In a place in the insulating films 241 and 243 that overlaps the light-blocking conducting film 238, a contact hole CH4 is formed in such a manner as to pass through the insulating films 241 and 243. The common electrode 240 is connected to the light-blocking conducting film 238 via the contact hole CH2. As shown in FIG. 8, the light-blocking conducting film 238 extends along a direction of extension of the source line 34A (Y-axis direction), and is electrically connected to the driver 17. The common electrode 24 is much larger in size than the pixel electrode 242 (pixel unit) in plan view, and is disposed in an range across pluralities of (e.g. approximately several tens or hundreds of) the pixel electrodes 242 in the X-axis direction and the Y-axis direction.

This makes it possible to use the light-blocking conducting film 238 as wires that are capable of transmitting signals to the position detection electrodes 240A. The source line 34A is connected to the driver 17, and the gate line 31A is connected, for example, to a gate driver 218 provided on the array substrate 222. The light-blocking conducting film 238 supplies the position detection electrodes 240A at different timings with a reference potential signal pertaining to the display function and a touch signal (position detection signal) pertaining to the touch function. This reference potential signal is transmitted to all of the light-blocking conducting films 238 at the same timing, and all of the position detection electrodes 240 are brought to a reference potential to function as the common electrode 240.

### Embodiment 4

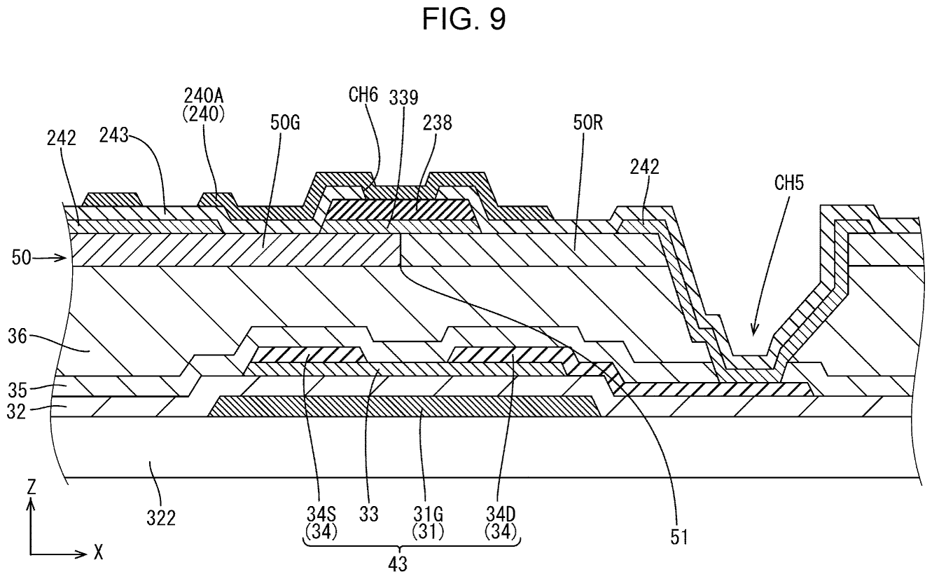

Next, Embodiment 4 of the present invention is described with reference to FIG. 9. A repeated description is omitted by assigning identical signs to components which are identical to those of the foregoing embodiment. The present embodiment differs from each of the foregoing embodiments in terms of a laminated structure on top of an array substrate 322. On top of the array substrate 322 of the present embodiment, as shown in FIG. 9, a pixel electrode 242, an insulating film 243, and a common electrode 240 (position detection electrode 240A) are stacked in this order on top of the color filter 50. The pixel electrode 242 is connected to the drain electrode 34D via a contact hole CH5 bored through the insulating film 35 and the planarizing film 36. As in the case of Embodiment 3 described above, the light-blocking conducting film 238 is placed in such a manner as to overlap a boundary portion 51 between two adjacent colored portions (in FIG. 9, the colored portions 50R and 50G) of the plurality of colored portions 50R, 50G, and 50B.

In a place in the insulating film 243 that overlaps the light-blocking conducting film 238, a contact hole CH6 is formed in such a manner as to pass through the insulating film 243. The common electrode 240 is connected to the light-blocking conducting film 238 via the contact hole CH6. Further, the present embodiment differs from Embodiment 3 (see FIG. 7) described above in that the pixel electrode 242 is placed at a lower level than the light-blocking conducting film 238. In the present embodiment, a transparent electrode film 339 is sandwiched between the light-blocking conducting film 238 and the color filter 50. The transparent electrode film 339 is placed at the same level as and made of the same material as the pixel electrode 242, and is formed at the same time as the pixel electrode 242 in the step of forming the pixel electrode 242. The transparent electrode film 339 bears the function of improving adhesion between the light-blocking conducting film 238 and the color filter 50. Further, stacking the transparent electrode film 339 and light-blocking conducting film 238 makes it possible to reduce interconnection resistance. The transparent electrode film 339 does not need to be sandwiched between the light-blocking conducting film 238 and the color filter 50.

### Embodiment 5

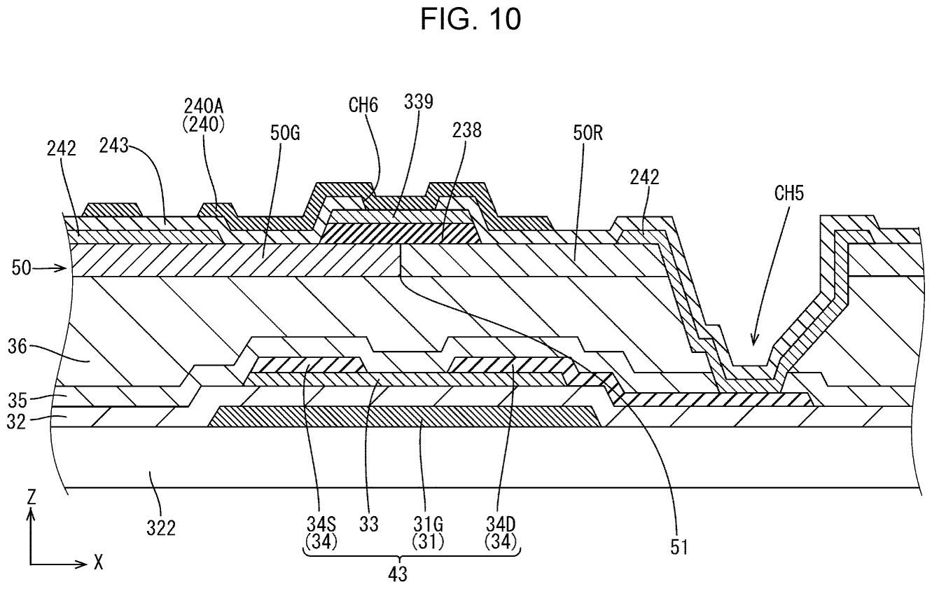

Next, Embodiment 5 of the present invention is described with reference to FIG. 10. A repeated description is omitted by assigning identical signs to components which are identical to those of the foregoing embodiment. As shown in FIG. 10, the present embodiment differs from Embodiment 4 described above in that the light-blocking conducting film 238 is placed at a lower level than the transparent electrode film 339. Placing the light-blocking conducting film 238 at a lower level than the transparent electrode film 339 makes it hard for the light-blocking conducting film 238 to be affected by heat generated by an annealing process that is performed after the formation of the contact hole CH6. As a result of this, the annealing process can be performed at a higher temperature, and a reduction in resistance of the transparent electrode film 339 can be achieved. Further, placing the transparent electrode film 339 at a higher level than the light-blocking conducting film 238 makes it possible to more surely prevent corrosion of the light-blocking conducting film 238.

Embodiment 4 described above is configured such that as shown in FIG. 9, the light-blocking conducting film 238 is placed at a higher level than the transparent electrode film 339 (and the pixel electrode 242). In this way, a conducting film that constitutes the transparent electrode film 339 (and the pixel electrode 242) and a conducting film that constitutes the light-blocking conducting film 238 can be continuously formed, and after that, the light-blocking conducting film 238 and the transparent electrode film 339 (and the pixel electrode 242) can be formed in this order by etching. On the other hand, in Embodiment 5, the formation of the conducting film that constitutes the light-blocking conducting film 238 and the formation of the light-blocking conducting film 238 by etching need to be followed by the formation of the conducting film that constitutes the transparent electrode film 339 (and the pixel electrode 242) and the formation of the transparent electrode film 339 (and the pixel electrode 242) by etching. That is, Embodiment 4 is advantageous over Embodiment 5 in terms of making it possible to reduce the number of steps, and Embodiment 5 is advantageous in terms of making it possible to reduce the resistance of the transparent electrode film 339 and prevent corrosion of the light-blocking conducting film 238.

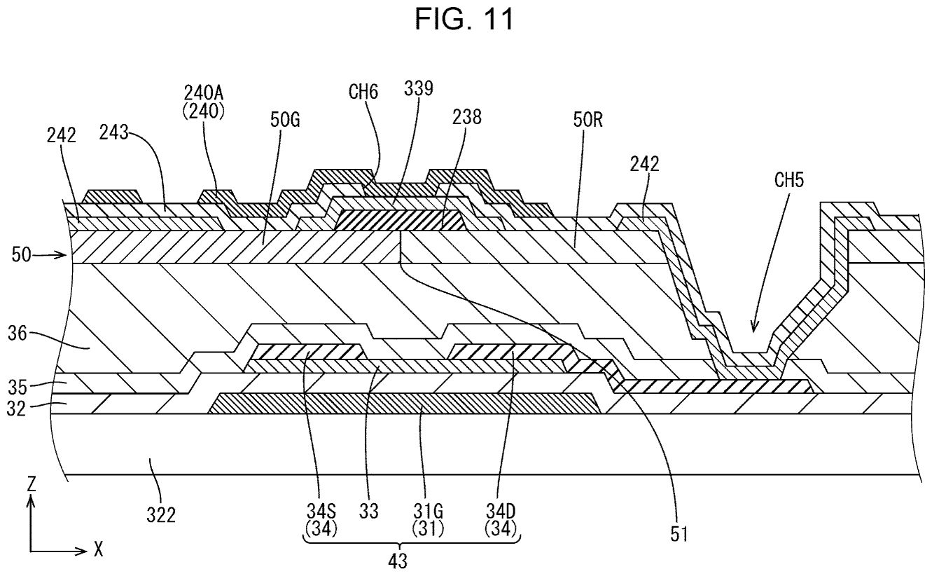

Alternatively, as shown in a modification of FIG. 11, the transparent electrode film 339 may be placed in such a manner as to cover a side surface of the light-blocking conducting film 238. This makes it possible to make the light-blocking conducting film 238 more resistant to corrosion and heat. The configuration shown in FIG. 10 is more advantageous than the configuration of FIG. 11 in terms of making it possible to etch the light-blocking conducting film 238 and the transparent electrode film 339 with the same mask and making it possible to reduce the width of the transparent electrode film 339.

### OTHER EMBODIMENTS

The present invention is not limited to the embodiments described above with reference to the drawings. The following embodiments may be included in the technical scope of the present invention.

(1) The materials of each conducting film and each insulating film are not limited to the materials illustrated in the foregoing embodiments but may be changed as appropriate.

(2) Each of the foregoing embodiments may be configured such that the light-blocking conducting film is placed on a side of the color filter opposite to the liquid crystal layer and the light-blocking conducting film and the common electrode are connected to each other via a contact hole bored through the color filter. When Embodiments 3 and 4 are configured such that the light-blocking conducting film 238 is placed on a side of the color filter 50 opposite to the liquid crystal layer, the distance in the Z-axis direction between the light-blocking conducting film 238, which serves as a wire, and the common electrode 240, which is not connected to the light-blocking conducting film 238, is greater by the thickness of the color filter 50. This causes a smaller parasitic capacitance to be formed between the light-blocking conducting film 238 and the common electrode 240, bringing about improvement in position detection sensitivity.

### REFERENCE SIGNS LIST

10 Liquid crystal display device
21 Counter substrate (which constitutes a pair of substrates)
22, 122, 222 Array substrate (first substrate)
23 Liquid crystal layer
34A Source line
34S Source electrode
38, 138, 238 Light-blocking conducting film
40 Common electrode
41 Insulating film
42, 242 Pixel electrode
43 TFT (switching element)
50 Color filter
50R, 50G, 50B Colored portion
110B Oxide semiconductor TFT (switching element)
240A Position detection electrode (common electrode)

1. A liquid crystal display device comprising:
a pair of substrates placed opposite each other;
a liquid crystal layer placed between the two substrates;
a plurality of switching elements provided on a first one of the two substrates;
a plurality of pixel electrodes provided on the first substrate, electrically connected to the plurality of switching elements, respectively, and placed closer to the liquid crystal layer than the plurality of switching elements;
a common electrode, provided on the first substrate, at least a part of which overlaps the pixel electrodes via an insulating film;
a color filter, provided on the first substrate, placed between the switching elements and the pixel electrodes, and placed in such a manner as to overlap each of the plurality of pixel electrodes, that includes a plurality of colored portions that exhibit different colors from one another; and
a light-blocking conducting film provided on the first substrate, placed closer to the liquid crystal layer than the switching elements while having a light blocking effect, placed in such a manner as to overlap a boundary portion between two adjacent colored portions of the plurality of colored portions, and electrically connected to the common electrode.

2. The liquid crystal display device according to claim 1, wherein the light-blocking conducting film is placed closer to the liquid crystal layer than the color filter.

3. The liquid crystal display device according to claim 1, wherein the light-blocking conducting film makes surface contact with the common electrode.

4. The liquid crystal display device according to claim 1, wherein the common electrode serves as a position detection electrode that forms an electrostatic capacitance with a position input body which performs a position input and that detects a position input performed by the position input body, and
the light-blocking conducting film is a wire that is capable of transmitting a signal to the position detection electrode.

5. The liquid crystal display device according to claim 1, wherein each of the switching elements includes a source electrode,
the first substrate is provided with a source line that is electrically connected to the source electrode, and
the light-blocking conducting film is placed in such a manner as to overlap the source line.

6. The liquid crystal display device according to claim 1, wherein each of the switching elements is a TFT including an oxide semiconductor.

7. The liquid crystal display device according to claim 6, wherein the oxide semiconductor contains indium (In), gallium (Ga), zinc (Zn), and oxygen (O).
